(19) United States
(12) Patent Application Publication
(10) Pub. No.: US 2016/0275503 A1
(43) Pub. Date: Sep. 22, 2016

(54) METHOD AND SYSTEM FOR REWARDING PARTIES IN A PAYMENT TRANSACTION VIA MANAGING CIRCULATION OF SMALL DENOMINATIONS OF CURRENCY

(71) Applicant: JOSEPH VAYALIL GEORGE, BANGALORE (IN)

(72) Inventor: JOSEPH VAYALIL GEORGE, BANGALORE (IN)

(21) Appl. No.: 14/968,885

(22) Filed: Dec. 14, 2015

Related U.S. Application Data
(60) Provisional application No. 62/090,896, filed on Dec. 12, 2014.

(51) Int. Cl. G06Q 20/40; G06Q 20/10

(52) U.S. Cl. CPC G06Q 20/401; G06Q 20/102; G06Q 50/26

(57) ABSTRACT

Embodiments of the present invention disclose systems for facilitating rewarding parties in a payment transaction via managing circulation of small denominations of currency, and methods therefor. Specifically, a system may facilitate proportionally rewarding all parties at least one of actively and passively involved in the payment transaction via managing circulation of small denominations of currency. In addition, the system may facilitate multilevel or multi-layer secure online and offline payment and related transactions. Specifically, the system may facilitate multilevel or multi-layer secure online and offline payment and related transactions via deployment of custom-designed POS configurations.

### BACKGROUND OF THE INVENTION

1. Field of the Invention

Embodiments of the present invention relate to reward management, and more particularly, to rewarding all parties at least one of actively and passively involved in a payment transaction via managing circulation of small denominations of currency.

2. Description of the Related Art

Points of Sale (POS) transactions are numerous throughout the world. Millions of people per day buy goods at stores and pay for the goods with cash, credit, debit cards or other means. When people use cash, change is given most of the time. The amount of change given worldwide, on any given day, is enormous.

A lottery is an event whose outcome is determined by chance. Lotteries are popular. In some lotteries, tickets are issued in advance and there is a weekly or monthly drawing to determine winners. Typically lotteries require a fixed price to buy a stake in the lottery and are not instantly decided.

Casino game play relies often on the concept of a lottery, particularly with slot machine play and other game play. A winner is determined by chance. Casino gaming machines typically require a fixed price to play the game.

The odds of winning a slot machine game are sometimes dependent on the fee paid by the gamer. In some slot machine games, the likelihood of winning increases with the amount paid to play the game. For example, when one coin, token, or credit is used, the odds of winning are limited, and when a few coins, tokens or credits are used the odds increase.

One problem is lotteries, like any form of gambling, are susceptible to fraud, despite the high degree of scrutiny claimed by the organizers. Numerous lottery scams exist. Some advance fee fraud scams on the Internet are based on lotteries. The fraud starts with spam congratulating the recipient on a recent lottery win of the recipient. The email explains that in order to release funds the email recipient must part with a certain amount (as tax/fees) as per the rules or risk forfeiture.

Another form of scam involves the selling of systems, which purport to improve a player's chances of selecting the winning numbers in a Lotto game. These scams are generally based on the buyer's (and perhaps the seller's) misunderstanding of probability and random numbers. Sale of the aforementioned systems or software is legal, however, since they mention that the product cannot guarantee a win, let alone a jackpot. There have also been several cases of cashiers at lottery retailers who have attempted to scam customers out of their winnings. Some locations require the patron to hand the lottery ticket to the cashier to determine how much they have won, or if they have won at all, the cashier then scans the ticket to determine one or both. In cases where there is no visible or audible cue to the patron of the outcome of the scan some cashiers have taken the opportunity to claim that the ticket is a loser or that it is worth far less than it is and offer to throw it away or surreptitiously substitute it for another ticket. The cashier then pockets the ticket and eventually claims it as own.

### SUMMARY

Embodiments of the present invention disclose systems for facilitating rewarding parties in a payment transaction via managing circulation of small denominations of currency, and methods therefor. Specifically, a system may facilitate proportionally rewarding all parties at least one of actively and passively involved in the payment transaction via managing circulation of small denominations of currency. In addition, the system may facilitate multilevel or multi-layer secure online and offline payment and related transactions. Specifically, the system may facilitate multilevel or multi-layer secure online and offline payment and related transactions via deployment of custom-designed POS configurations.

Embodiments of the present invention disclose a system for rewarding all parties in a payment transaction. The system comprises a server subsystem. The server subsystem comprises at least a host computing unit comprising a server-side application, a client subsystem comprising one or more Point-of-Sale (POS) configuration units, wherein the POS configuration units are custom-designed thereby facilitating managing tampering, and wherein each of the POS configuration units comprise a client-side application, and wherein both the server-side and client-side applications are based on a proprietary algorithm, and a network subsystem comprising at least one wired and wireless networks, thereby facilitating proportionally rewarding all parties in the payment transaction via managing circulation of small denominations of currency whilst ensuring a win-win situation of the parties including government. All the parties at least one of actively and passively involved in the payment transaction may be proportionally rewarded via digitizing at least one of loose change and small denominations of currency constituting at least one of a portion and residual value of the total amount of money received as disbursement against at least one of products purchased and services availed and dispensing certificates analogous to the at least one of portion and residual value of the total amount of money. The payment and related transactions may be at least one of multilevel and multi-layer secure online and offline payment and related transactions implemented via deployment of custom-designed POS configurations. The custom-designed POS configurations may be at least one of at least one of tamper resistant, tamper-detective, tamper-evident, tamper-responsive and a combination thereof thereby facilitating at least one of multilevel and multi-layer secure online and offline payment and related transactions. The custom-designed POS configurations may comprise a tamper-resistant microprocessor used to store and process at least one of private and sensitive information, and wherein the tamper-resistant microprocessor may be designed to at least one of zeroize, delete and distort the sensitive data therein.

### BRIEF DESCRIPTION OF THE DRAWINGS

FIG. 1 depicts a system for rewarding parties in a payment transaction via managing circulation of small denominations of currency, according to one or more embodiments;

FIG. 2 depicts an exemplary all-in-one POS configuration for deployment in the fixed/static mode in retail environments, according to one or more embodiments; and

FIG. 3 depicts a computer system that is a computing device and can be utilized in various embodiments of the present invention, according to one or more embodiments.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the method and system is described herein by way of example for several embodiments and illustrative drawings, those skilled in the art will recognize that the method and system for rewarding parties in a payment transaction via managing circulation of small denominations of currency, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and system for rewarding parties in a payment transaction via managing circulation of small denominations of currency defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of the present invention disclose systems for facilitating rewarding parties in a payment transaction via managing circulation of small denominations of currency, and methods therefor. Specifically, a system facilitates proportionally rewarding all parties at least one of actively and passively involved in the payment transaction via managing indirect circulation of small denominations of currency. In addition, the system facilitates multi-level or multi-layer secure online and offline payment and related transactions. Specifically, the system facilitates multi-level or multi-layer secure online and offline payment and related transactions via deployment of customized POS configurations, designed and implemented in accordance with the principles of the present invention.

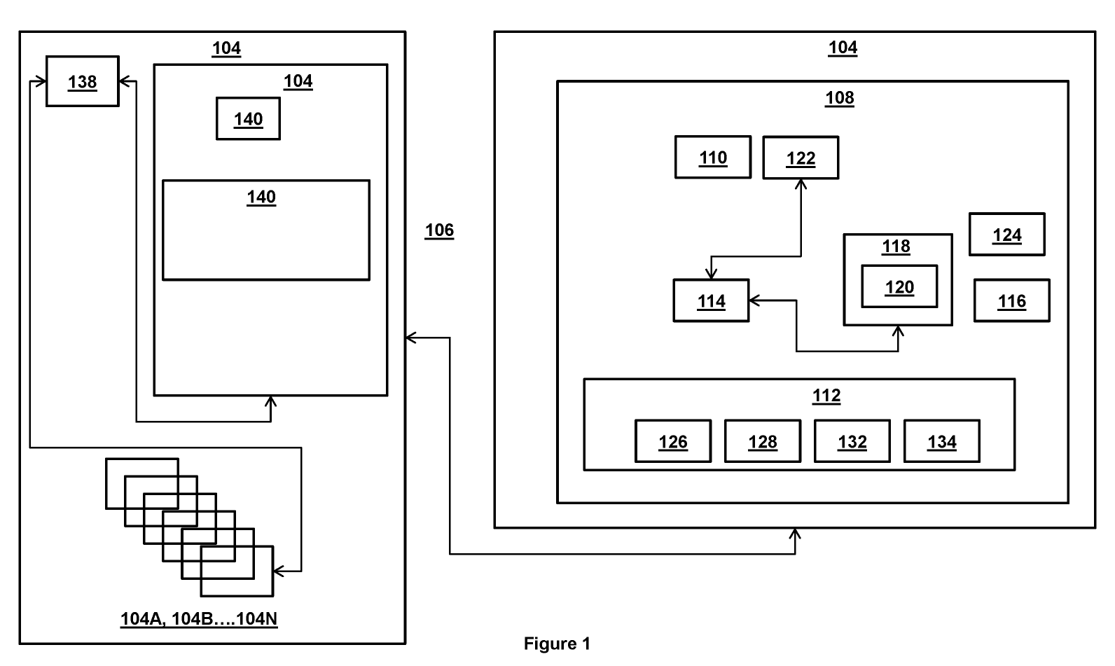

FIG. 1 depicts a system for rewarding parties in a payment transaction via managing circulation of small denominations of currency, according to one or more embodiments.

The system 100 is in essence a secure and an unbiased reward management system, thereby facilitating managing indirect circulation of small denominations of currency. The system 100 comprises a server subsystem 102, client subsystem 104 and network subsystem 106.

The system 100 facilitates securely and impartially rewarding parties in any payment transaction. Specifically, the system 100 facilitates securely, impartially and proportionally rewarding all parties (participants or stakeholders) at least one of actively and passively involved in any payment transaction. More specifically, the system 100 facilitates securely, impartially and proportionally rewarding all parties at least one of actively and passively involved in any payment transaction via managing indirect circulation of small denominations of currency, for instance coin (or loose change) and paper, through conversion of the small denominations of currency into at least one of electronic and non-electronic currency analogues (or proxies) therefor via generation and usage of the same.

Still more specifically, the system 100 facilitates generating and using at least one of electronic and a non-electronic currency analogues of small denominations of currency involved in any payment (or financial) transaction made in connection with settlement of an invoice comprising at least one of the price, fee and tariff payable by a customer against at least one of a product purchased and service availed, in turn, correspondingly receivable by at least one of a seller and service provider. In addition, the system 100 facilitates as at least one of physically issuing and electronically transmitting the at least one of corresponding non-electronic and electronic currency analogues of the small denominations of currency, which are qualitatively equivalent whilst quantitatively equal thereto, involved in any payment (or financial) transaction.

The server subsystem 102 comprises one or more host computing units 108. Each of the host computing units 108 comprises a first microprocessor subunit 110, first memory subunit 112, first Input/Output subunit 114 and first set of support circuits 116, respectively. In addition, the host computing unit 108 comprises a first communication subunit 118 coupled to the first I/O subunit 114. The first communication subunit 118 comprises a first wireless transceiver 120.

For example, and in no way limiting the scope of the invention, the first wireless transceiver 120 comprises at least one of a General Packet Radio Service (GPRS) transceiver, Global System for Mobile Communications (GSM) transceiver, Near Field Communication (NFC) transceiver, BLUETOOTH® transceiver, and the like. In addition, each of the host computing units 108 comprises a first display subunit 122. In some embodiments, both the first communication subunit 118 and first display subunit 122 are coupled to the first I/O subunit 114. In addition, each of the host computing units 108 comprises a first positioning subunit 124. For example, and in no way limiting the scope of the invention, the first positioning subunit 124 is based on Global Positioning System (GPS).

The first memory sub-unit 112 comprises a first Operating System (OS) 126. Specifically, the first OS 126 is a platform agnostic/independent OS. In addition, the first memory sub-unit 112 comprises a server-side 128 of a proprietary Service-Oriented Architecture (SOA)-based Reward-As-A-Service (SOARAAS) application (app) 130. The proprietary SOAPSAAS application (app) 130 is in essence a client-server application, which is a distributed system made up of both client and server software.

In addition, the first memory sub-unit 112 comprises a database 132, and a Database Management System (DBMS) 134. For example, and in no way limiting the scope of the invention, the database 132 is at least one of a centralized and distributed database.

In operation, the proprietary client-server SOARAAS application (app) 130 provides a better way to share the workload. A client-side 134 of the proprietary client-server SOARAAS application (app) 130 always initiates a connection to the server, for instance the sever subsystem 102 comprising the host computing unit 108, while the server-side 128 of the proprietary client-server SOARAAS application (app) 130 always waits for requests from any client, for instance the client subsystem 104.

The term “Service-Oriented Architecture or SOA” refers to an architectural pattern in computer software design, wherein application components provide services to other components via a communications protocol, typically over a network. The principles of service-orientation are independent of any vendor, product or technology, thereby rendering the SOA at least one of vendor, product, technology agnostic and a combination thereof.

In some embodiments, the client subsystem 104 comprises one or more of at least one of a portable computing device, portable communications device and a combination thereof, for instance a portable computing and communications device.

In some embodiments, the portable computing devices are at least one of a portable computer, tablet computer, Personal Digital Assistant (PDA), an ultra mobile PC, a smart phone, carputer, portable communications, pentop computer, and the like. Likewise, in some embodiments, the portable communications devices are at least one of a mobile device, and the like.

In some embodiments, the client subsystem 104 comprises one or more of at least one of a wearable computing device, wearable communications device and a combination thereof, for instance a wearable computing and communications device. For example, and in no way limiting the scope of the invention, the wearable computing devices are at least one of a smart watch, smart band, smart glass, and the like.

In some embodiments, the at least one of smart portable and wearable computing and communications device 104 is coupled to a portable peripheral device 138. For example, and in no way limiting the scope of the invention, the portable peripheral device 138 is at least one of a portable printer and portable 3D printer.

In some embodiments, a smart fixed computing and communications device 104 is coupled to a fixed peripheral device 138. For example, and in no way limiting the scope of the invention, the fixed peripheral device 138 is a printer.

In some embodiments, the at least one of portable and wearable computing and communications device 104 comprises a second microprocessor subunit 140, second memory subunit 142, a second Input/Output (I/O) subunit 144 and second set of support circuits 146, respectively. In addition, the at least one of portable and wearable computing and communications device 104 comprises a second communication subunit 148 coupled to the second I/O subunit 144. The second communication subunit 148 comprises a second wireless transceiver 150.

For example, and in no way limiting the scope of the invention, the second wireless transceiver 150 comprises at least one of a General Packet Radio Service (GPRS) transceiver, Global System for Mobile Communications (GSM) transceiver, Near Field Communication (NFC) transceiver, BLUETOOTH® transceiver, and the like. In addition, the at least one of portable and wearable computing and communications device 104 comprises a second display subunit 152. In some embodiments, both the second communication subunit 144 and second display subunit 152 are coupled to the second I/O subunit 144. In addition, the at least one of portable and wearable computing and communications device 104 comprises a second positioning subunit 154. For example, and in no way limiting the scope of the invention, the second positioning subunit 154 is based on Global Positioning System (GPS).

The second memory subunit 142 comprises a second OS 156. For example, and in no way limiting the scope of the invention, the second OS 156 is a mobile OS. Specifically, the mobile OS 156 is a platform agnostic mobile OS. For instance, the platform agnostic mobile OS 156 is ANDROID™ OS. Upon downloading and installation of the client-side 134 of the proprietary client-server SOARAAS application (app) 130, the second memory subunit 142 comprises the second OS 156 and the client-side 134 of the proprietary client-server SOARAAS application (app) 130, designed and implemented in accordance with the principles of the present invention.

In some embodiments, the client subsystem 104 comprises one or more POS configurations 104A, 104B . . . 104N. Each of the one or more POS configurations 104A, 104B . . . 104N is at least one of owned, operated and a combination thereof, by each of one or more users. For example, and in no way limiting the scope of the invention, at least one of the POS configurations is at least one of a mobile and fixed POS. Specifically, the one or more users are vendors or suppliers or sellers or service providers. For example, and in no way limiting the scope of the invention, each of the one or more vendors or suppliers or sellers or service providers are at least one of a taxicab staff/driver/owner, grocery store staff/owner, laundry shop staff/owner, bus driver/conductor/owner, an auto rickshaw driver/owner, a retail POS staff/operator/owner, a hospitality POS staff/operator/owner, and the like.

In use, a buyer-side user, for instance a buyer, purchaser, consumer or customer, of the system 100 buys or purchases at least one of a product, solution and service. Upon at least one of buying the product and availing service, the user is requested or required to pay to the vendors or suppliers or sellers or service providers the at least one of price and fare against an invoice raised. In some average and worst case scenarios, the user is not carrying cash equal to exact amount as per the invoice raised against at least one of the product purchased and service availed. For example, and in no way limiting the scope of the invention, in some worst case scenarios, the user carries only large denominations of currency, and thus fails to tender the exact amount as per the invoice raised against at least one of the product purchased and service availed.

In use, a seller-side user, for instance a vendor or seller or service provider, of the system 100 access and initiates the client-side 134 of the proprietary client-server SOARAAS application (app) 130 from the at least one of the smart portable and wearable computing and communications device 104 coupled to the portable peripheral device 138. For example, and in no way limiting the scope of the invention, the portable peripheral device 138 is at least one of a portable printer and portable 3D printer.

Reiterating again, in some embodiments, a smart fixed computing and communications device 104 is coupled to a fixed peripheral device 138. For example, and in no way limiting the scope of the invention, the fixed peripheral device 138 is a printer.

In use, both the buyer-side and seller-side users mutually agree to split the total amount of the invoice raised against at least one of the product purchased and service availed, in at least one of in part and in entirety into one or more at least one of payable, convertible portions, and combinations thereof. Further, in use, the seller-side user reimburses the payable portions in cash and issues at least one of electronic and non-electronic currency analogues of the convertible portions to the buyer-side user.

In some embodiments involving a payment transaction made in connection with the settlement of an invoice corresponding to at least one of a price, fee and tariff payable by a customer to at least one of seller and service provider against at least one of a product purchased and service availed thereby, the customer (or buyer-side user) disburses an amount at least one of at and above par relative to the invoice raised thereto by the at least one of seller and service provider (or seller-side user). In some average and worst case scenarios, in at least one of the events wherein A) the at least one of customer and seller is devoid of necessary and sufficient small denominations of currency, B) the at least one of customer and seller fails to procure necessary and sufficient small denominations of currency and C) absence of necessary and sufficient small denominations of currency with the at least one of customer and seller, leads to at least one of provisional and permanent failure in completion of a payment transaction so as to successfully settle the invoice. For example, and in no way limiting the scope of the invention, the invoice amount comprises at least one of large denominations and small denominations of currency and combinations thereof. As a consequence, in some average and worst case scenarios, the customer is at least one of compelled, and thus manages to disburse an amount at least one of at and above par relative to the invoice raised. In response, the seller is bound to reimburse the excess amount to the customer, wherein the excess amount yet again comprises at least one of large denominations and small denominations of currency and combinations thereof.

In use, the seller accesses and initiates the client-side 134 of the proprietary client-server SOARAAS application (app) 130. In some scenarios, the system 100 facilitates determining one or more optimal trade-offs between A) cash reimbursement in part and B) issuance of at least one of non-electronic and electronic currency analogues in part, thereby facilitating successful and complete reimbursement of the excess amount by the seller to the buyer. Specifically, the one or more optimal disbursement trade-offs are determined at least one of fully manually mutually by the seller and buyer and partly manually mutually by the seller and buyer using the client-side 134 of the proprietary client-server SOARAAS application (app) 130, and recommendations made thereby.

Upon determination of the one or more optimal disbursement trade-offs, the system 100 facilitates at least one of partly manual and fully automated identification, analysis, and selection of at least one most optimal disbursement trade-off. Upon identification, analysis, mutual agreement and final selection of the most optimal disbursement trade-off, the seller A) makes cash reimbursement in part and B) issues at least one of non-electronic and electronic currency analogues in part, as determined and recommended thereby facilitating successful and complete reimbursement of the excess amount by the seller to the buyer.

In some embodiments, the system facilitates managing a database comprising at least a plurality of payment transactions, in turn, facilitating selectively impartially and proportionally rewarding all parties at least one of actively and passively involved in each of the payment transactions, in accordance with the principles of the present invention. Specifically, the system facilitates capturing one or more payment transactions, uploading the captured payment transactions thereto, processing the uploaded payment transactions and downloading the processed payment transactions therefrom, thereby facilitating selectively impartially and proportionally rewarding all parties at least one of actively and passively involved in each of the payment transactions. More specifically, processing the uploaded payment transactions comprises 1) analyzing the payment transactions based on one or more attributes, both quantitative and qualitative, thereof, 2) profiling the payment transactions based on analyses, 3) categorizing the payment transactions based on profiling, 4) recommending intended payment transactions, and 5) tracking efficacy of the recommended payment transactions. For example, and in no way limiting the scope of the invention, the primary, secondary, tertiary, and so on, attributes of each of the payment transactions comprises A) at least one of basic and optional overall profile of users, both buyers and sellers, B) periodic, for instance daily, weekly, fortnightly, monthly, quarterly, semi- or bi-annually, annually, and the like, frequency of payment transactions per user, periodic average value of payment transactions of at least one of users and per user, C) periodic average time duration of payment transactions of at least one of users and per user, D) periodic frequency or number of payment transactions comprising same sellers and different buyers, E) periodic frequency or number of payment transactions comprising same buyers and different sellers, F) periodic sales profile (or behaviour or pattern) of sellers, G) periodic purchase or buying profile (or behaviour or pattern) of buyers, and the like.

In use, the client-side 134 of the proprietary client-server SOARAAS application (app) 130 facilitates capturing the payment transactions, and one or more attributes of all parties at least one of actively and passively participating therein as well as other requisite entities and parameters, such as time, date, location, and the like, accessing the database 132 residing in the first memory sub-unit 112 of the host computing units 108 of the server subsystem 102, uploading the captured information or data in at least one of online and offline mode to the database 132 residing in the first memory sub-unit 112 of the host computing units 108 of the server subsystem 102, querying the database 132, retrieving the information or data stored therein.

Further, in use, the server-side 128 of the proprietary SOARAAS application (app) 130 facilitates at least one of regulatory agency, regulatory authority, regulatory body, regulator and independent regulatory agency in managing the database 132 residing in the first memory sub-unit 112 of the host computing units 108 of the server subsystem 102. Specifically, the server-side 128 of the proprietary SOARAAS application (app) 130 in conjunction with the DBMS facilitates in storing the payment transactions records of users, processing the stored payment transactions records of users, for instance analyzing the payment transactions records of users, profiling the payment transactions records of users based on the attributes thereof, assigning scores to users based, for example on the primary, secondary, tertiary, and so on, attributes of each of the payment transactions records comprises A) at least one of basic and optional overall profile of users, both buyers and sellers, B) periodic, for instance daily, weekly, fortnightly, monthly, quarterly, semi- or bi-annually, annually, and the like, frequency of payment transactions per user, periodic average value of payment transactions of at least one of users and per user, C) periodic average time duration of payment transactions of at least one of users and per user, D) periodic frequency or number of payment transactions comprising same sellers and different buyers, E) periodic frequency or number of payment transactions comprising same buyers and different sellers, F) periodic sales profile (or behaviour or pattern) of sellers, G) periodic purchase or buying profile (or behaviour or pattern) of buyers, H) periodic frequency or number of payment transactions comprising same sellers and same buyers, and the like, categorizing the users based on assigned scores, and corresponding payment transactions records thereof, recommending intended payment transactions to users and transactions with highest assigned score, and tracking efficacy of recommended intended payment transactions made in connection with at least one of buying products, procuring solutions and availing services.

In some embodiments, the system facilitates taking into consideration all parties or stakeholders at least one of actively and passively involved in any payment transaction, namely the provider/developer of the proprietary SOARAAS application (app) 130, the network service provider, the buyer, the seller, the provider/developer of the customized POS device, the at least one of regulatory agency, regulatory authority, regulatory body, regulator and independent regulatory agency. Specifically, the system facilitates securely, impartially and proportionally rewarding all parties or stakeholders at least one of actively and passively involved in the payment transaction. More specifically, the system facilitates identifying, analyzing and selecting at least one payment transaction record with the highest assigned score for purposes of securely, impartially and proportionally rewarding all parties or stakeholders at least one of actively and passively involved in the corresponding payment transaction.

In some scenarios involving payment transactions comprising active participation of at least one of A) same sellers against or vis-à-vis different buyers, B) same buyers against or vis-à-vis different sellers and C) same sellers against or vis-à-vis same buyers, the corresponding payment transactions facilitate in at least one of 1) capturing at least one of purchase and sales data or information (activity, pattern or behaviour) of at least one of sellers and buyers, 2) analyzing the at least one of sellers and buyers based on at least one of captured sales and purchase data or information (activity, pattern or behaviour), 3) profiling the at least one of sellers and buyers based on the analyses, 4) assigning scores to the at least one of sellers and buyers based on sales profiles (activity, pattern or behaviour) of sellers and purchase profiles of buyers, for instance assigning loyalty points offered from same sellers to same buyers (return customers) involved in payment transactions with active participation of same sellers against or vis-à-vis same buyers, assigning royalty points to any and all passive parties involved in payment transactions, thereby facilitating incrementing the overall score assigned to corresponding payment transactions.

The system 100 may facilitate rewarding parties in a payment transaction via managing circulation of small denominations of currency. Specifically, the system 100 may facilitate proportionally rewarding all parties at least one of actively and passively involved in the payment transaction via managing circulation of small denominations of currency. More specifically, the system 100 may facilitate proportionally rewarding all parties at least one of actively and passively involved in the payment transaction via digitizing small denominations of currency. Still more specifically, the system 100 may facilitate proportionally rewarding all parties at least one of actively and passively involved in the payment transaction via digitizing at least one of loose change and small denominations of currency constituting at least one of a portion and residual value of the total amount of money received as disbursement against at least one of products purchased and services availed and dispensing certificates (or tokens or tickets) analogous to the at least one of portion and residual value of the total amount of money. For example, the residual money given back when a customer hands over more than the exact price of an item (or small denominations of money given in exchange for a larger denomination) may be digitized and stored as digital record and certificates (or tokens or tickets) analogous to the residual money may be dispensed. The system 100 may facilitate multilevel or multi-layer secure online and offline payment and related transactions. Specifically, the system 100 may facilitate multilevel or multi-layer secure online and offline payment and related transactions via deployment of custom-designed POS configurations.

In some embodiments, deployment of the POS configuration in the fixed/static mode in retail environments is disclosed, in accordance with the principles of the present invention.

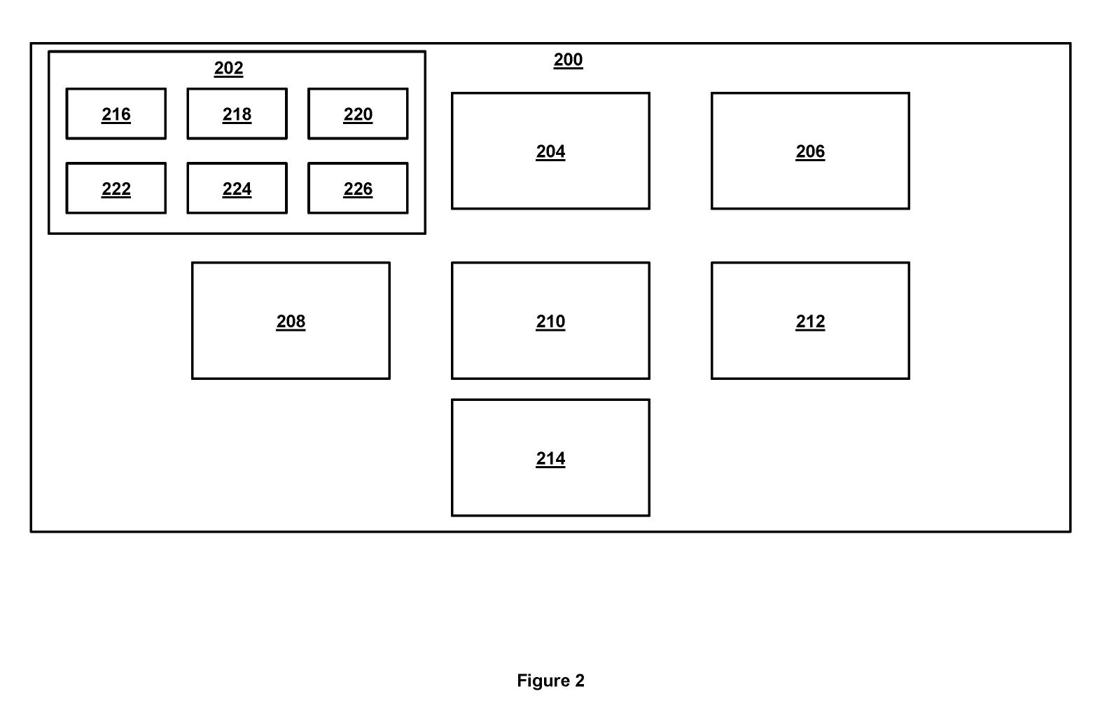

FIG. 2 depicts an exemplary all-in-one POS configuration for deployment in the fixed/static mode in retail environments, according to one or more embodiments.

The all-in-one POS configuration 200 may comprise a cash register 202, debit/credit card reader 204, conveyor belt 206, weight scale 208, signature capture unit 212, customer Personal Identification Number (PIN) pad unit 214 and an integrated credit card processing unit 210.

The cash register 202 may comprise a computing subunit 216, monitor 218, cash drawer 220, receipt printer 222, customer display 224 and barcode scanner 226.

In some embodiments, for example, and in no way limiting the scope of the invention, the monitor 218 may use touch-screen technology for ease of use. In addition, the computing unit 216 may be built into the chassis of the monitor 218 for what is referred to as an all-in-one configuration. All-in-one POS configurations liberate counter space for the retailer. In some embodiments, the all-in-one POS configuration may comprise proprietary POS application software. The POS application software may be capable of handling myriad customer based functions, such as sales, returns, exchanges, layaways, gift cards, gift registries, customer loyalty programs, promotions, discounts and much more. The POS application software may facilitate functions, such as pre-planned promotional sales, manufacturer coupon validation, foreign currency handling and multiple payment types.

In some scenarios, the POS configuration in the fixed/static mode in retail environments may facilitate handling the sales to the consumers, however handling the sales may be only one part of the entire POS configuration used in a retail business. In some scenarios, back-office computers may facilitate handling other functions of the entire (or end-to-end) POS configuration, such as inventory control, purchasing, receiving and transferring of products to and from other locations. Other typical functions of the entire POS configuration may be to store sales information for enabling customer returns, reporting purposes, sales trends and cost/price/profit analysis. Specifically, customer information may be stored for receivables management, marketing purposes and specific buying analysis. In some scenarios, many retail POS configurations may include an accounting interface that feeds sales and cost of goods information to independent accounting applications.

In some embodiments involving one or more retail operations, such as hardware, electronic stores and multifaceted super-stores, one or more specialized additional features compared to other stores may be needed. The POS application software in the retail operations mentioned forthwith may facilitate handling special orders, purchase orders, repair orders, service and rental programs as well as typical POS functions. In some scenarios involving deployment of POS configurations in outdoor environments, rugged hardware may be required. Further, wireless devices, battery powered devices, all-in-one units, and Internet-ready machines are typical in the retail industry. In some embodiments, the POS transactions may be conducted using mobile phones and tablets.

In some embodiments involving deployment of the POS configurations in the hospitality industry is disclosed, in accordance with the principles of the present invention. The hospitality POS configurations may be computerized systems incorporating registers, computers and peripheral equipment, usually on a computer network to be used in restaurants, hair salons or hotels. Like other POS configurations, the hospitality POS configurations may facilitate keeping track of sales, labor and payroll, and may facilitate generation of records used in accounting and book keeping. The hospitality POS configurations may facilitate remote access thereto by restaurant corporate offices, troubleshooters and other authorized parties.

In some embodiments, the POS device may be at least one of at least one of tamper resistant, tamper-evident and a combination thereof, implemented in accordance with the principles of the present invention.

In some embodiments involving deployment of a Trusted Platform Module (TPM) may facilitate the secure generation of cryptographic keys, and limitation of use thereof, in addition to a random number generator. The TPM may also include capabilities, such as remote attestation and sealed storage. By virtue of the remote attestation capability, the TPM may facilitate creating a hash key summary of the hardware and software configuration of any TPM enabled POS configuration. Specifically, the program hashing the configuration data may facilitate determining the extent of the summary of the software, in turn, facilitating a third party to verify that the software has not been changed. By virtue of the Binding capability, the TPM may facilitate encrypting data using TPM bind key, a unique RSA key descended from a storage key. By virtue of the sealing capability, the TPM may facilitate encrypting data in a similar manner to binding, but in addition may facilitate specifying a state in which TPM must be in order for the data to be decrypted (unsealed).

In some embodiments, use of a TPM by software for facilitating authenticating hardware devices is disclosed In some scenarios, each TPM chip may have a unique and secret RSA key burned in at the time of production; thereby facilitating performing platform authentication.

In some embodiments, pushing the security down to the hardware level in conjunction with software may provide relatively more protection vis-à-vis a software-only solution. However, in some scenarios involving use of a TPM, a key may still be vulnerable while a software application that may have obtained the key from TPM may be using the same to perform encryption/decryption operations, for instance as in the case of a cold boot attack. In some embodiments, the aforementioned problem may be eliminated in accordance with the principles of the present invention. For instance, if key(s) used in TPM may not accessible on a bus or to external programs and, thus, all encryption/decryption may be done in TPM.

In some embodiments, a TPM enabled user device, for instance the POS device, may be capable of communicating with a TPM enabled server in the network cloud. In use, the user may facilitate registering for a secure drive on the TPM enabled server. The TPM enabled server may facilitate detecting and authorizing the TPM enabled device of the user. Also, the TPM enabled server may facilitate providing key pair for secure interaction between user device and secure drive. The data security may be provided for the server through crypto controllers that include TPM software based crypto engine, RSA, and ECC engine.

In some embodiments, the POS device may be at least one of at least one of tamper resistant, tamper-detective, tamper-evident, tamper-responsive and a combination thereof, implemented in accordance with the principles of the present invention. The POS device may facilitate multi-level or—layer security via taking into consideration one or more factors thereby facilitating reducing the risk of tampering. By way of example, and in no way limiting the scope of the invention, the one or more factors may be at least one of 1) identifying who may be a potential tamperer, for instance at least one of average user, child, psychopath, misguided joker, saboteur, organized criminals, terrorists and a combination thereof; 2) determining what level of knowledge, materials, tools, etc. the potential tamperer may have at his/her disposal?; 3) identifying all feasible methods, for instance at least one of primary and secondary, of unauthorized access into the POS device; 4) at least one of controlling and limiting access to the POS device; 5) improving the tamper resistance to make tampering more difficult, time-consuming, etc.; 6) adding tamper-evident features to help indicate the existence of tampering; and 7) educating people to watch for evidence of tampering.

In some embodiments, the POS device may comprise a tamper-resistant microprocessor used to store and process private or sensitive information, such as private keys or electronic money credit. Specifically, in order to prevent an attacker from retrieving or modifying the information, the tamper-resistant microprocessor may be designed so that the information is not accessible through external means and may be accessed only by the embedded software, which may contain the appropriate security measures. In some embodiments, the POS device may be capable of facilitating managing the following attacks, namely 1) physical attack of various forms, such as micro-probing, drills, files, solvents, etc.; 2) freezing the device; 3) applying out-of-spec voltages or power surges; 4) applying unusual clock signals; 5) inducing software errors using radiation, such as microwaves or ionizing radiation; and 6) measuring the precise time and power requirements of certain operations.

In some embodiments, the tamper-resistant microprocessor may be designed to at least one of zeroize, delete and distort the sensitive data therein, for instance especially cryptographic keys, in the event that the tamper-resistant microprocessor may detect penetration of the security encapsulation or out-of-specification environmental parameters therefor. In some embodiments, the tamper-resistant microprocessor may even be rated for cold zeroization, i.e. the ability to zeroize the sensitive data therein despite, or subsequent to, removal of power supply therefor. In addition, the custom-made encapsulation methods used for the tamper-resistant microprocessor of the POS device may be designed in such a manner that the tamper-resistant microprocessor may be internally pre-stressed, thereby leading to the fracture of the tamper-resistant microprocessor in the event of any interference therewith if interfered.

In some embodiments, the resistance to tampering may be at least one of built in the POS device and added to packaging therefor. For example, the extra layer(s) of packaging, packaging that requires tools to enter, extra-strong and secure packaging, packaging that cannot be resealed and tamper-evident seals and features.

In some embodiments, the POS software may be tamper-resistant. Specifically, the POS software may comprise measures to make reverse engineering harder, or to prevent a user from modifying the POS software against the manufacturer's wishes, for instance removing a restriction on how to use. For example, design and implementation of source or machine code that may be difficult to interpret known as code obfuscation.

In some embodiments, the POS device may be a portable computing and communications device.

For purposes of clarity and expediency, the POS device may be hereinafter interchangeably referred to as a “mobile POS device,” “portable POS device” and “handheld POS device”.

In some embodiments involving cloud computing environments, deployment of the POS configuration in at least one of the fixed/static, portable, mobile modes, and a combination thereof, based on Software-as-a-Service (SAAS) delivery model is disclosed, in accordance with the principles of the present invention. Specifically, the cloud-based POS configuration may facilitate licensing and delivery of POS software for implementation on one or more POS devices on a subscription basis. The POS software may be hosted on a SAAS server and may be accessed directly by users using a thin client, i.e. SAAS client running on a POS device, from the Internet using an internet or web browser. In some embodiments, advanced communication protocols for POS's control of hardware, cloud-based POS systems are independent from platform and operating system limitations. Cloud-based POS systems are also created to be compatible with a wide range of POS hardware and sometimes tablets such as Apple's IPad. Thus cloud-based POS also helped expand POS systems to mobile devices.

In use, a customer may at least one of buy/purchase a product and avail a service and may have to pay a vendor or supplier at least one of selling the product and rendering the service. In some scenarios, the customer may wish to pay in cash against at least one of the product purchased and service availed. In some scenarios, the amount of at least one of bill and invoice raised against the at least one of the product purchased and service availed may be at least one of through at least one of Each of the one or more POS configurations 102A, 102B . . . 102N may be at least one of owned, operated and a combination thereof, by each of one or more users. Specifically, the one or more users may be vendors or suppliers. More specifically, for example, and in no way limiting the scope of the invention, each of the one or more vendors or suppliers may be at least one of a taxicab driver/owner, grocery store owner, laundry shop owner, bus conductor, an auto rickshaw driver/owner, a retail POS operator/owner, a hospitality POS operator/owner, and the like.

In some embodiments, the methods for payment may be classified into two types, namely exchanging and provisioning. Exchanging is to change coins, money and banknotes in terms of the price. Provisioning is to transfer money from one account to another. In provisioning, a third party must be involved. Further, credit card, debit card, cheque (check in US), money transfers, and recurring cash or Automated Clearing House (ACH) disbursements are all electronic payments methods. Electronic payments technologies employ magnetic stripe card, smartcard, contactless card and mobile handset. Specifically, mobile handset based payments are called mobile payments.

In some embodiments, the payments may be classified by the number of parties involved to consummate a transaction. For example, a credit card transaction in the United States requires a minimum of four parties, namely the purchaser, the seller, the issuing bank, and the acquiring bank. On the other hand, a cash payment requires a minimum of three parties, namely the seller, the purchaser, and the issuer of the currency.

In some embodiments, the system may facilitate mobile payment, in accordance with the principles of the present invention.

In some embodiments management, specifically monitoring, an escrow account associated with and/or owned by buyers generated during payment transactions made between the buyers and one or more sellers is disclosed, in accordance with the principles of the present invention. In some scenarios, upon successful execution of the payment transactions amidst buyers and sellers using the POS device, design and implemented in accordance with the principles of the present invention, buyers may be required or requested to download a proprietary application from at least one of a Direct Download Link (DDL) supplied via clicking the same and the app store on the portable computing and communications owned by the buyers via searching for the proprietary app for monitoring the escrow account. Specifically, the proprietary app may facilitate monitoring at least one of the following parameters associated with the escrow account of the buyers: 1) the cash credited back against the payments made in excess of the exact prices for at least one of products sold (or offered) and services rendered by given sellers or service providers, 2) loyalty points earned therefor as return buyers relative to given sellers, and the like. For example, and in no way limiting the scope of the invention, the proprietary app may be an ANDROID™ based app (ANDROID app). In some embodiments, the proprietary app may be bundled with a portable code that may be easily installed and executed by end users, i.e. widget. In use, the widget may facilitate exhibiting the status of the escrow accounts and the results of one or more cash rewards programs executed. In some embodiments, at least one of a web portal and On-Device Portal (ODP) may facilitate buyers to visit the relevant home or index page thereupon and view the status of the escrow accounts and the results of one or more cash rewards programs executed. In some scenarios, one or more files that may contain only the locations of another files in the portable computing and communications devices owned by the buyers may also be created on the home or index page thereby facilitating fast or quick access to the proprietary app.

In some embodiments, at least one of the stakeholders in or parties to the payment transactions may be makers of the proprietary POS configurations capable of providing or rendering the escrow account management and rewarding related services thereof, in accordance with the principles of the present invention.

In some embodiments involving new users, upon successful downloading and installation of at least one of a proprietary application software, web application/app, and mobile application/app, the new users may be required or requested to sign up or register with the proprietary application software. Upon successful sign up or registration, the proprietary app may be accessed and initiated by the new users for the first time. The new users may be required to at least register and sign up with the proprietary app thereby facilitating creation of valid login-credentials, for instance a User Identification (UID or User ID) and Password (PWD), of each of the new users. In some scenarios, the new users may be required or requested to key-in the Mobile Identification Number (MIN), Mobile Subscription Identification Number (MSIN) or Subscriber Identification Number (SIN) associated the portable computing and communications devices owned by the new users, as a mandatory requirement. The MIN or MSIN may be subjected to automatic verification via transmission of an SMS to each of the portable computing and communications devices owned by each of the new users. The proprietary app may read the SMS received on each of the portable computing and communications devices and validate the correctness of the MIN or MSIN keyed-in by each of the new users. Upon successful validation, each of the new users may be required or requested to enter a name, PWD, and a master PWD thereby facilitating completion of the registration or sign up process. In use, the PWDs may facilitate authentication of each of the new users. Further, the master PWDs may facilitate authentication of other connected devices, which may be integrated later for using the proprietary app. Further, upon successful validation, the new user may be required or requested to register the biometric details therefor, for instance the Fingerprint (FP) and input personal details, for instance name. Still further, the new user may be requested or required to choose a password and a master password to complete the sign up process. The FP may serve as a primary source of authentication for the POS device to work. In the event that the POS device fails to at least one of capture and identify the FP of the return user, i.e. a successfully registered new user, the return user may use the password feature to unlock the POS device.

In some embodiments, the POS configuration may be procured from payment device-cum-service providers.

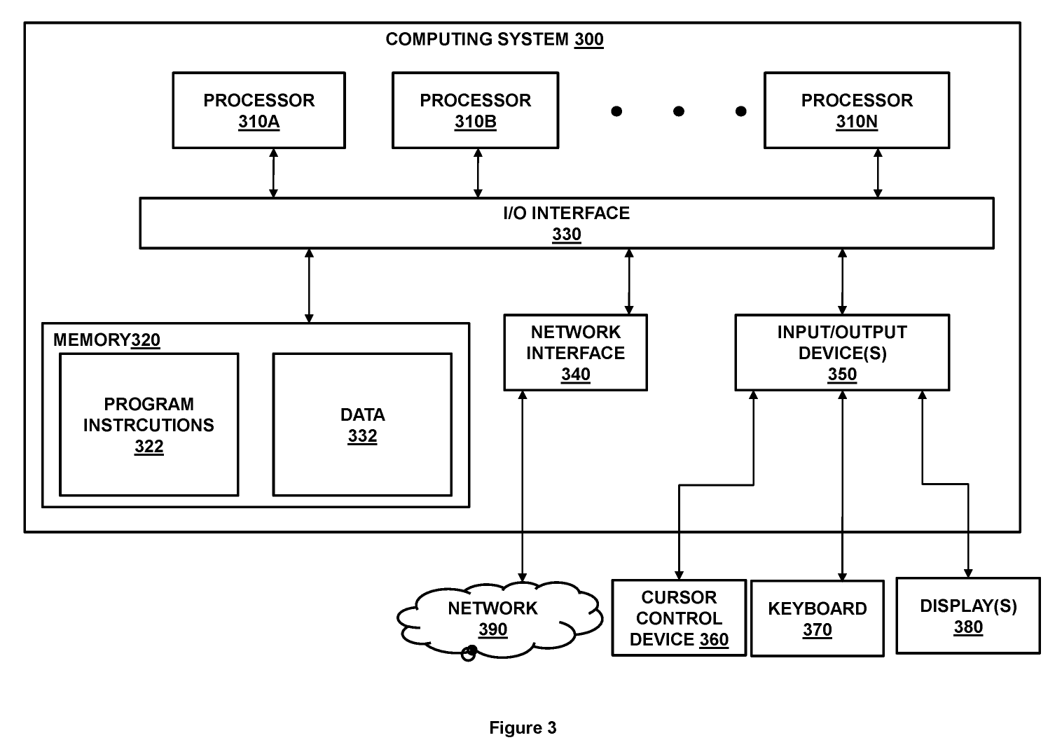

FIG. 3 depicts a method for rewarding all parties in a payment transaction via managing indirect circulation of small denominations of currency, according to one or more embodiments.

The method 300 starts at step 302 and proceeds to step 304.

At step 304, the method 300 facilitates, or comprises, manually accepting from a buyer disbursement of a payment against an invoice raised for at least one of a product purchased, solution procured and service availed by a seller.

At step 306, the method 300 facilitates, or comprises, initiating a client-side of a proprietary client-server SOARAAS application (app), for instance the client-side 134 of the proprietary client-server SOARAAS application (app) 130, on at least one of smart portable computing and communications devices 104 owned by each of the buyer and seller.

At step 308, the method 300 facilitates, or comprises, at least one of mutually manually and partially manually determining an optimal ratio or proportion of amount to be reimbursed in cash is to amount to be converted into currency analogue quantitatively equal to the small denominations of currency constituting the total disbursable amount by the seller to the buyer.

At step 310, the method 300 facilitates, or comprises, accepting and inputting the at least one of a mutually manually determined and partially manually recommended, for instance using the client-side 134 of the proprietary client-server SOARAAS application (app) 130, the most optimal ratio or proportion of the amount to be reimbursed in cash is to the amount to be converted into currency analogue quantitatively equal to the small denominations of currency constituting the total disbursable amount by the seller to the buyer.

At step 312, the method 300 facilitates, or comprises, issuing at least one of non-electronic and electronic currency analogues of the amount to be converted into currency analogue quantitatively equal to the small denominations of currency constituting the total disbursable amount by the seller to the buyer. Specifically, the electronic issuance of the currency analogues of the amount to be converted into currency analogue quantitatively equal to the small denominations of currency constituting the total disbursable amount is performed by transmitting the currency analogues from the smart portable computing and communications device 104 of the seller to that of the buyer.

At step 314, the method 300 facilitates, or comprises, uploading the details of the payment transaction in connection with the payment disbursed by the buyer and the excess amount reimbursed by the seller at least one of in online and offline mode to the database 132 hosted on the server subsystem 102.

At step 316, the method 300 facilitates, or comprises, managing the details of the payment transaction as a payment transaction record.

At step 318, the method 300 facilitates, or comprises, repeating the steps 304-316 for each time a payment transaction is made.

At step 320, the method 300 facilitates, or comprises, processing each of the payment transaction records for assigning scores to the same for use on periodic basis for the purposes of rewarding all parties at least one of actively and passively involved therein. Specifically, the processing of each of the payment transaction records comprises analyzing the payment transactions records of users, profiling the payment transactions records of users based on the attributes thereof, assigning scores to users based, for example on the primary, secondary, tertiary, and so on, attributes of each of the payment transactions records comprises A) at least one of basic and optional overall profile of users, both buyers and sellers, B) periodic, for instance daily, weekly, fortnightly, monthly, quarterly, semi- or bi-annually, annually, and the like, frequency of payment transactions per user, periodic average value of payment transactions of at least one of users and per user, C) periodic average time duration of payment transactions of at least one of users and per user, D) periodic frequency or number of payment transactions comprising same sellers and different buyers, E) periodic frequency or number of payment transactions comprising same buyers and different sellers, F) periodic sales profile (or behaviour or pattern) of sellers, G) periodic purchase or buying profile (or behaviour or pattern) of buyers, H) periodic frequency or number of payment transactions comprising same sellers and same buyers, and the like, categorizing the users based on assigned scores, and corresponding payment transactions records thereof, recommending intended payment transactions to users and transactions with highest assigned score, and tracking efficacy of recommended intended payment transactions made in connection with at least one of buying products, procuring solutions and availing services.

At step 322, the method 300 facilitates, or comprises, periodically rewarding all parties at least one of actively and passively involved in a selected payment transaction based on the highest assigned score therefor.

At step 324, the method 300 ends.

### Example Computer System

FIG. 4 depicts a computer system that is a computing device and can be utilized in various embodiments of the present invention, according to one or more embodiments.

Various embodiments of method and system for rewarding parties in a payment transaction via managing circulation of small denominations of currency, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement one or more methods described above. The computer system 400 may be used to implement any other system, device, element, functionality or method of the above-described embodiments. In the illustrated embodiments, computer system 400 may be configured to implement one or more methods as processor-executable executable program instructions 422 (e.g., program instructions executable by processor(s) 410A-N) in various embodiments.

In the illustrated embodiment, computer system 400 includes one or more processors 410A-N coupled to a system memory 420 via an input/output (I/O) interface 430. The computer system 400 further includes a network interface 440 coupled to I/O interface 430, and one or more input/output devices 450, such as cursor control device 460, keyboard 470, and display(s) 480. In various embodiments, any of components may be utilized by the system to receive user input described above. In various embodiments, a user interface (e.g., user interface) may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410A-N may be any suitable processor capable of executing instructions. For example, in various embodiments processors 410 may be general-purpose or embedded processors implementing any of a variety of instruction set architectures (ISAs), such as the ×96, POWERPC®, SPARC®, or MIPS® ISAs, or any other suitable ISA. In multiprocessor systems, each of processors 410A-N may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one components (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A system for rewarding all parties in a payment transaction, the system comprising:
a server subsystem comprising:
at least a host computing unit comprising a server-side application;
a client subsystem comprising one or more Point-of-Sale (POS) configuration units, wherein the POS configuration units are custom-designed thereby facilitating managing tampering, and wherein each of the POS configuration units comprise a client-side application, and wherein both the server-side and client-side applications are based on a proprietary algorithm; and
a network subsystem comprising at least one wired and wireless networks, thereby facilitating proportionally rewarding all parties in the payment transaction via managing circulation of small denominations of currency whilst ensuring a win-win situation of the parties including government.

2. The system of claim 1, wherein all the parties at least one of actively and passively involved in the payment transaction are proportionally rewarded via converting to currency analogues at least one of loose change and small denominations of currency therefor constituting at least one of a portion and residual value of the total amount of money received as disbursement against at least one of products purchased and services availed, and dispensing currency analogues analogous to the at least one of portion and residual value of the total amount of money.

3. The system of claim 1, wherein the payment and related transactions are at least one of multilevel and multi-layer secure online and offline payment and related transactions implemented via deployment of custom-designed POS configurations.

4. The system of claim 3, wherein the custom-designed POS configurations are at least one of at least one of tamper resistant, tamper-detective, tamper-evident, tamper-responsive and a combination thereof thereby facilitating at least one of multilevel and multi-layer secure online and offline payment and related transactions.

5. The system of claim 4, wherein the custom-designed POS configurations comprises a tamper-resistant microprocessor used to store and process at least one of private and sensitive information, and wherein the tamper-resistant microprocessor designed to at least one of zeroize, delete and distort the sensitive data therein.
